(19) United States
(12) Patent Application Publication
(10) Pub. No.: US 2002/0062924 A1
(43) Pub. Date: May 30, 2002

(54) Definable integrated passives for circuitry

(76) Inventors: William F. Hartman, Albuquerque, NM (US); Kirk M. Slenes, Albuquerque, NM (US); Kristen J. Law, Scottsdale, AZ (US)

Correspondence Address: PEACOCK MYERS AND ADAMS P C, P O BOX 26927, ALBUQUERQUE, NM, 871256927

(21) Appl. No.: 10/052,863

(22) Filed: Nov. 9, 2001

Related U.S. Application Data
(63) Continuation-in-part of application No. 09/458,363, filed on Dec. 9, 1999.
Application No. 09/458,363 is a continuation-in-part of application No. 09/305,253, filed on May 4, 1999.
(60) Provisional application No. 60/084,104, filed on May 4, 1998.
(60) Provisional application No. 60/247,583, filed on Nov. 9, 2000.

(51) Int. Cl. B31C 1/00

(52) U.S. Cl. 156/307.3; 156/187

(57) ABSTRACT

A method of fabricating a passive integrated circuit. The integrated circuitry is fabricated in a single plane, the circuitry including passive components such as capacitors, resistors, and inductors. The method features the steps of forming on a substrate a first pattern of conductive material and a first set of passive component elements, and depositing a patterned dielectric layer onto the substrate. The first pattern of conductive material provides electrical connectivity to the first set of passive component elements. An apparatus fabricated according to method is disclosed

### CROSS-REFERENCE TO RELATED APPLICATIONS

This application is a continuation-in-part application of U.S. patent application Ser. No. 09/458,363, entitled “Dielectric Material Including Particulate Filler”, filed on Dec. 9, 1999, and of U.S. patent application Ser. No. 09/305,253, entitled “Integral Capacitance for Printed Circuit Board Using Dielectric Nanopowders”, filed on May 4, 1999, both by William F. Hartman, Kirk M. Slenes, and Kristen J. Law, and the specifications thereof are incorporated herein by reference. The latter application claimed the benefit of the filing of U.S. Provisional Patent Application Serial No. 60/084,104, entitled “Integral Capacitance for Printed Circuit Board Using Dielectric Nanopowders”, filed on May 4, 1998, and the specification thereof is also incorporated herein by reference.

This application claims the benefit of the filing of U.S. Provisional Patent Application Serial No. 60/247,583, entitled “Definable Integrated Passives for Advanced Circuitry”, filed on Nov. 9, 2000, and the specification thereof is incorporated herein by reference.

### GOVERNMENT RIGHTS

The U.S. Government has a paid-up license in this invention and the right in limited circumstances to require the patent owner to license others on reasonable terms as provided for by the terms of Grant No. DMI-9761618 awarded by the U.S. National Science Foundation.

### BACKGROUND OF THE INVENTION

1. Field of the Invention (Technical Field)

The present invention relates to integrated passive circuitry designs and fabrication thereof.

2. Background Art

Traditional integrated passives are fabricated in a multi-layer construction with each plane serving a single function. Connection of the passives to the surface mounted active components is achieved through circuit patterning and vias that serve as conductive paths between individual layers. Illustrative of the prior art are U.S. Pat. Nos. 5,578,860, 5,818,090, 5,923,077, 5,998,275, and 6,021,050. The present invention provides the capability to form or insert multiple electrically functional components within the same plane.

### SUMMARY OF THE INVENTION (DISCLOSURE OF THE INVENTION)

Thus, there is provided according to the invention a method of forming integrated circuitry in a single plane, the circuitry comprising a plurality of passive components selected from the group consisting of capacitors, resistors, and inductors, the method comprising the steps of forming on a substrate a first pattern of conductive material and a first set of passive component elements, and depositing a patterned dielectric layer onto the substrate, wherein the first pattern of conductive material provides electrical connectivity to the first set of passive component elements. Preferably, in the forming step the substrate comprises alumina. Also, in the forming step the first set of passive component elements optionally comprises interdigitated capacitor electrodes. The method may also comprise the step of forming a floating plane over the dielectric layer. Optionally, in the forming step the first set of passive component elements may comprise a first set of electrodes of a set of parallel plate capacitors.

The inventive method additionally may also comprise the further step of forming a second pattern of conductive material and a second set of passive component elements wherein the second pattern of conductive material provides electrical connectivity to the second set of passive component elements. The second set of passive component elements preferably comprises a second set of electrodes of a set of parallel plate capacitors paired with the first set of electrodes.

The inventive method additionally may also comprise the step of forming a second pattern of conductive material and a second set of passive component elements, wherein the second pattern of conductive material provides electrical connectivity to the second set of passive component elements.

Thus, there also is provided according to the present invention an integrated circuit in a single plane formed by the aforementioned process of the invention. The circuit may comprise a plurality of interdigitated capacitor electrodes.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a cross-section view of an interdigitated capacitor apparatus of the invention, formed according to the method of the present invention (arrows indicate electric field vectors);

FIG. 2 is a cross-section view of an interdigitated capacitor with floating plate formed according to the method of the present invention (arrows indicate electric field vectors); and

FIG. 3 is a cross-section view of a parallel-plate capacitor formed according to the present invention (arrows indicate electric field vectors).

### DESCRIPTION OF THE PREFERRED EMBODIMENTS (BEST MODES FOR CARRYING OUT THE INVENTION)

The present invention is a novel integrated passive (capacitor, resistor and inductor) design and construction process involving definition of electrically functional materials. The primary advantage of the technology is the capability to form or insert multiple electrically functional components within the same plane. Connection of passive to active components is made using standard circuit patterns. In contrast, traditional integrated passives are fabricated in a multi-layer construction with each plane serving a single function. Connection of the passives to the surface mounted active components is achieved through circuit patterning and vias that serve as conductive paths between individual layers.

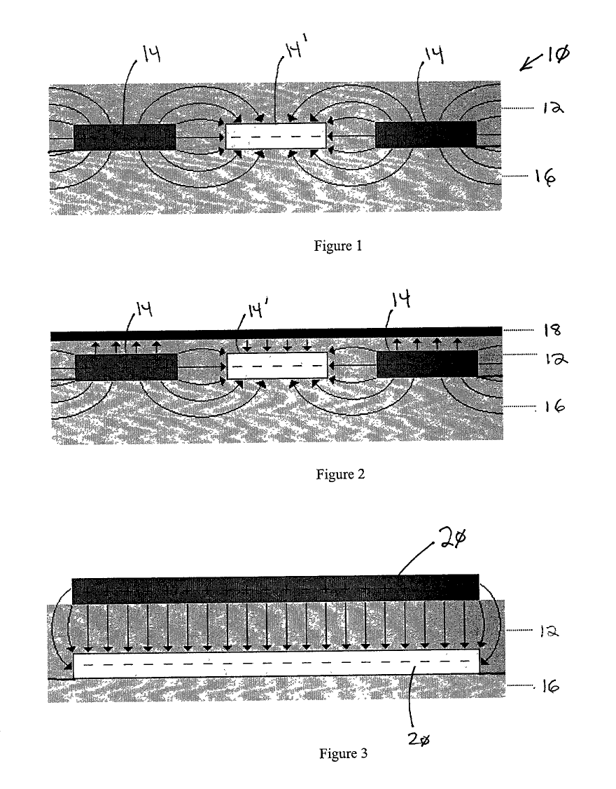

The present invention is illustrated herein for capacitors. As understood by one of ordinary skill in the art, the invention can be appropriately modified for resistors and inductors, through substitutions of component compositions, as generally known in the art. As in conventional designs, the capacitor design of the present invention includes opposing conductive electrodes separated by a dielectric. Distinct from conventional designs, the capacitor design of the present invention includes definition or patterning of the dielectric. The dielectric layer is formed in specific areas on one or both electrode surfaces. In the case of an interdigitated electrode pattern 10, the dielectric 12 is deposited on both electrodes 14,14′ (see FIG. 1) on a substrate 16 (e.g., alumina). A floating plate electrode 18 can be added, which increases the electric field and capacitance (see FIG. 2). In the case of a parallel plate electrode pattern, the dielectric is placed between two parallel plate electrodes 20,20′ (see FIG. 3).

The preferred process sequence for fabrication of a parallel plate capacitor incorporating the integrated passive design of the present invention is described below. Similar processes are used for resistors and inductors.

1. A bottom electrode pattern is formed on an electrical substrate, e.g., alumina, using conventional plating, photoresist and/or etching processes.

2. A photo or ultraviolet sensitive dielectric layer is coated onto the entire substrate using conventional film forming processes such as spin or dip coating.

3. The dielectric layer is preferentially exposed to ultraviolet radiation to induce curing or polymerization of the dielectric coating.

4. The unexposed dielectric coating is removed from the electrical substrate through solvent washing. (Specific areas of the dielectric coating remain over the bottom electrode pattern.)

5. A top electrode patterned is formed above the bottom electrode pattern on top of the dielectric coating.

6. Connection to the top and bottom capacitor planes is made through circuit patterns formed with the bottom and top electrodes.

Note that definition of the electrically functional materials is not limited to photo patterning. Physical masking or other processes can also be used for preferential deposition.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of forming integrated circuitry in a single plane, the circuitry comprising a plurality of passive components selected from the group consisting of capacitors, resistors, and inductors, the method comprising the steps of:
forming on a substrate a first pattern of conductive material and a first set of passive component elements; and
depositing a patterned dielectric layer onto the substrate;
wherein the first pattern of conductive material provides electrical connectivity to the first set of passive component elements.

2. The method of claim 1 wherein in the forming step the substrate comprises alumina.

3. The method of claim 1 wherein in the forming step the first set of passive component elements comprises interdigitated capacitor electrodes.

4. The method of claim 3 additionally comprising the step of forming a floating plane over the dielectric layer.

5. The method of claim 1 wherein in the forming step the first set of passive component elements comprises a first set of electrodes of a set of parallel plate capacitors.

6. The method of claim 5 additionally comprising the step of forming a second pattern of conductive material and a second set of passive component elements wherein the second pattern of conductive material provides electrical connectivity to the second set of passive component elements.

7. The method of claim 6 wherein the second set of passive component elements comprises a second set of electrodes of a set of parallel plate capacitors paired with the first set of electrodes.

8. The method of claim 1 additionally comprising the step of forming a second pattern of conductive material and a second set of passive component elements wherein the second pattern of conductive material provides electrical connectivity to the second set of passive component elements.

9. An integrated circuit in a single plane formed by the process of claim 1.

10. The circuit of claim 9 comprising a plurality of interdigitated capacitor electrodes.
